(19) United States
(12) Patent Application Publication
(10) Pub. No.: US 2010/0227984 A1
(43) Pub. Date: Sep. 9, 2010

(54) HYDROLYSIS-RESISTANT POLY (p-PHENYLENEBENZOBISOXAZOLE) (PBO) FIBERS

(76) Inventors: Thuy DANG, Wright Patterson AFB, OH (US); Paul E. Liggett, Wooster, OH (US); Dhiraj H. Darjee, Wadsworth, OH (US); Daniel H. Jones, Akron, OH (US); James I. Mascolino, North Canton, OH (US)

Correspondence Address: RENNER KENNER GREIVE BOBAK TAYLOR & WEBER, FIRST NATIONAL TOWER, SUITE 400, 106 SOUTH MAIN STREET, AKRON, OH, 44308-1412, US

(21) Appl. No.: 12/398,411

(22) Filed: Mar. 5, 2009

(51) Int. Cl. B29C 47/00; C08G 59/16

(52) U.S. Cl. 525/450; 264/103

(57) ABSTRACT

Rigid-rod polymer fiber filaments, such as poly (p-phenylenebenzobisoxazole) (PBO), having improved retention of physical properties are prepared by preparing a polymer solution and extruding that solution to form a filament, and then treating that filament with water, base solution, and water. The treated filament may be further heat-treated, or further treated with water. The treated filaments are less susceptible to the degradation caused by heat, humidity, and UV radiation.

### TECHNICAL FIELD

The present invention relates to synthetic fibers. More specifically, the present invention relates to a method of preparing rigid-rod polymer fibers that are resistant to hydrolysis.

### BACKGROUND

Aromatic heterocyclic rigid-rod polymers are well known for their desirable mechanical properties and their thermal and thermo-oxidative stabilities. For instance, commercialized versions of poly(p-phenylene-benzobisoxazole) (PBO) fibers have been used to create high-performance materials used in such products as flame/heat-resistant fabrics, ballistic vests, balloons, satellites, sailcloth, yacht ropes, golf clubs, and as reinforcement for cement, belts, and tires.

However, it is known that PBO fibers do not maintain their physical properties over time. PBO is susceptible to degradation which reduces the mechanical performance of the fibers. As a result, the performance of the products containing the PBO fibers is also diminished. Exposure to environmental conditions such as moisture, heat, and UV radiation over time contributes to the degradation of PBO fibers. It is believed that residual acid from the manufacture of the PBO fibers contributes to the hydrolytic instability of the fibers and hastens the degradation of the fibers' performance.

Post-fabrication fiber treatments to reduce the susceptibility of PBO to degradation under adverse environmental conditions have not succeeded. For example, extraction using supercritical carbon dioxide has been attempted as a way to remove traces of phosphoric acid from PBO fibers. Extraction using supercritical carbon dioxide, followed by treatment of the PBO fibers with low molar mass base compounds (such as pyridine and morpholine) has also been attempted. However, these efforts have proven to be ineffective, time-consuming and costly.

Thus, a need exists for a method of preparing rigid-rod polymer fibers that are resistant to hydrolysis and its performance degrading effects.

### SUMMARY OF THE INVENTION

In light of the foregoing, it is a first aspect of the present invention to provide hydrolysis-resistant PBO fibers.

It is another aspect of the present invention to provide a method of preparing a rigid-rod polymer fiber comprising the steps of preparing a polymer solution, extruding the polymer solution to form a filament, and exposing the filament to an aqueous base solution.

Yet another aspect of the present invention is to provide a rigid-rod polymer having a residual acid content of less than about 1.00 percent phosphoric acid content by weight.

### BRIEF DESCRIPTION OF THE DRAWINGS

These and other features and advantages of the present invention will become better understood with regard to the following description, appended claims, and accompanying figures wherein:

FIG. 1 is a schematic representation of a system suitable for the continuous dry-jet wet spinning and treatment of PBO fibers;

FIG. 2 is a plot of test result data showing the median percent tenacity and elongation retained in inventive and prior-art PBO fibers after exposure to adverse temperature and humidity conditions;

FIG. 3 is a plot of test result data showing the median percent tenacity retained in inventive and prior-art PBO fibers after exposure to UV radiation; and

FIG. 4 is a plot of test result data showing the median percent elongation retained in inventive and prior-art PBO fibers after exposure to UV radiation.

### BEST MODE FOR CARRYING OUT THE INVENTION

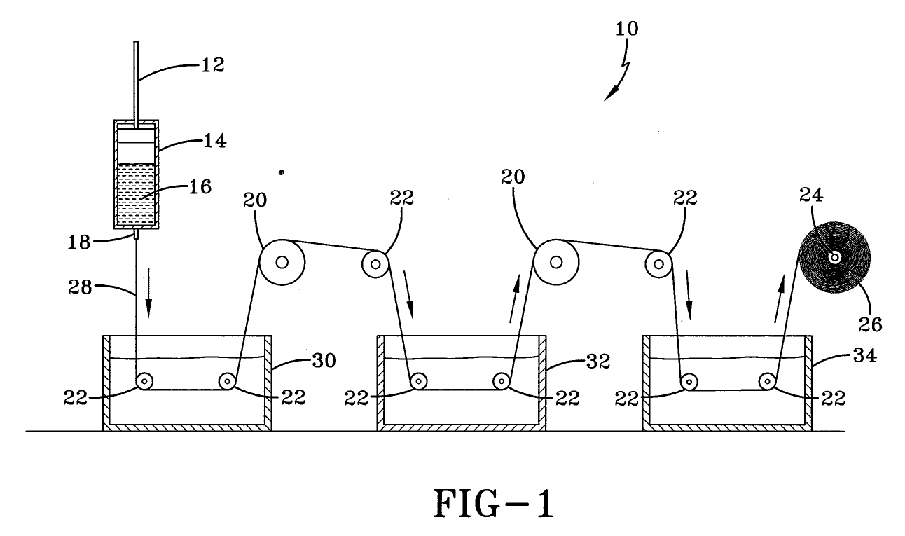

Referring now to FIG. 1, a system for preparing rigid-rod polymer fibers according to the present invention is designated generally by the number 10. The system 10 includes an extrusion device 12 associated with a tank 14 holding a polymer solution 16, and a spinneret 18. The system 10 also includes driven rollers 20, guide rollers 22, a wind-up roller 24 including a bobbin 26. An extruded PBO monofilament fiber, or a yarn made up of numerous filaments, is designated by the number 28. For the purposes of this disclosure, the term “fiber” describes a monofilament or yarns made up more than one filament. The system 10 also includes a first water bath 30, a base bath 32, and a second water bath 34. The system is used for preparing rigid-rod polymer fibers as follows.

Rigid-rod polymer fibers may be made from compositions prepared according to methods known in the art. For example, a composition to be made into rigid-rod PBO fibers may be prepared by combining selected ratios of terephthaloyl chloride, 4,6-diaminorescorcinol dihydrochloride, and an approximate 77 percent polyphosphoric acid (PPA) solution. The terephthaloyl chloride and the 4,6-diaminorescorcinol dihydrochloride can each make up from about 11 to about 21 percent of the combination. And the PPA solution can make up to about 67 to about 77 percent of the combination. The monomers are stirred in the PPA and the composition is dehydrochlorinated over a period of 24 hours under a nitrogen flow after slowly raising the reaction temperature to 105° C. to avoid foaming. The composition is cooled and a selected amount of phosphorous pentoxide (P₂O₅), about 26 grams, is added to provide the PPA solution with about 83 percent P₂O₅ content and to ensure a final polymer concentration of about 14 percent by weight in PPA. The composition is maintained and stirred at 100° C. to ensure good homogeneity and the temperature is slowly raised to 165° C. and the polymerization reaction is allowed to run for several hours. The polymerization reaction is continued at a final temperature of 180° C. for 24 hours. The resulting polymer composition, also known as “polymer dope,” may be processed into rigid-rod PBO fibers using the system 10. Although the method for preparing rigid-rod polymer fibers described below relates to PBO fibers prepared by spinning from a dope (polymer solution) of polyphosphoric acid (PPA) solution, the method may also be applied to other rigid-rod polymer fibers, such as 2,6-naphthalene PBO, that are created from raw materials in (concentrated) acidic solution.

PBO fibers may be made according to the concepts of the present invention as follows. Tank 14 holds a quantity of polymer solution 16 (PBO polymer dope in acid, prepared as described above) that is pushed by the extrusion device 12 through the spinneret 18. The opening (die) of a typical monofilament spinneret has a diameter of 20 mil (0.5 mm), though the concepts of the present invention are not limited to using a spinneret having such dimensions. The polymer solution 16 is forced through the opening in the spinneret 18 and forms an extruded PBO fiber monofilament 28. Of course, a spinneret having multiple holes could also be used, and the polymer solution 16 would be forced through the multiple holes creating several extruded PBO fiber filaments which could be combined and made into a larger PBO fiber yarn according to methods well known in the art. Given an appropriate supply of raw materials, the PBO fiber 28 may be produced continuously. In one or more embodiments, a dry-jet wet spinning technique is used with temperatures in roughly the 90-100° C. range, pressures in the roughly 1000-1200 psi range, and draw ratios as high as 40-50.

As the PBO fiber 28 is extruded from the spinneret 18, driven rollers 20 and guide rollers 22 pull the PBO fiber 28 through the first water bath 30, base bath 32, and second water bath 34 before the PBO fiber 28 is wound by the wind-up roller 24 onto the bobbin 26, forming a spool of PBO fiber. Of course, other arrangements of rollers could also be used to carry the PBO fiber through the three baths, such as one where a wind-up roller is the only driven roller and the other rollers are passive guide rollers. And, other arrangements of water and base baths could be used, such as one where the extruded PBO fibers are taken through multiple water baths before exposure to a base bath. Or, the base bath could precede any water bath. In any event, the steps discussed herein allow the removal of residual acid from the fiber during processing by exposing the extruded fiber to a neutralizing reagent (base), such as a solution of ammonium hydroxide. By treating the fibers soon or immediately after extrusion, the fibers are permeable to the neutralizing reagent. In addition to being applicable to PBO fibers, as discussed below, it is believed the present invention is equally applicable to a wide variety of polymer fibers, especially the class of “rigid-rod” polymers.

As the PBO fiber 28 is created at the spinneret 18, it passes through an air gap, then directly into the first water bath 30. The PBO fiber 28 is completely submerged in the water of the first water bath 30, and this water bath treatment washes away or dilutes any residual acid on the PBO fiber 28. In the present embodiment, the water is continuously replaced with a fresh (neutral) supply. The water bath treatment also keeps the PBO fiber 28 wet. The PBO fiber 28 is guided out of the first water bath, then into the base bath 32 and completely submerged in the basic solution contained therein. The base bath treatment neutralizes residual acid in or on the PBO fiber 28. The base bath solution is replenished and filtered as needed. Then, the PBO fiber 28 is guided into the second water bath 34 and is completely submerged in the water therein. This water bath treatment washes away residual acid, base or salt on the PBO fiber 28. As before, the water is likely continuously replaced. Finally, the PBO fiber 28 is guided out of the second water bath 34 and is wound by the wind-up roller 24 onto the bobbin 26, forming a spool of PBO fiber. In the present embodiment, the first water bath 30 and the second water bath 34 contain distilled water, and the base bath 32 contains a 5 percent aqueous ammonium hydroxide solution. Alternatively, the base bath 32 may include a solution of an alkali (proton-accepting) acid-neutralizing agent(s) other than ammonium hydroxide, preferably volatile, as long as the alkali acid-neutralizing agent is of sufficient concentration to neutralize any residual acid in the PBO fiber 28. Optionally, the spool of PBO fiber may be immersed in distilled water for a period of time (such as several days) to remove any traces of base, and then air-dried. After washing, the PBO fiber may also be heat treated to improve physical properties.

In order to demonstrate the practice of the present invention, the following examples have been prepared and tested. The examples should not, however, be viewed as limiting the scope of the invention.

### EXAMPLES

A quantity of PBO fiber monofilament was prepared according to the concepts of the present invention as follows. Into a resin flask fitted with a high torque mechanical stirrer, a nitrogen inlet/outlet adapter and a side-opening for addition, was placed 12.1824 grams (g) of terephthaloyl chloride, 12.7836 g of 4,6-diaminorescorcinol dihydrochloride, and 54.54 g of a 77 percent polyphosphoric acid (PPA) solution. The monomers were stirred in the PPA and the composition was dehydrochlorinated over a period of 24 hours under a nitrogen flow after slowly raising the reaction temperature to 105° C. to avoid foaming. The composition was cooled and 26.64 g of phosphorous pentoxide (P₂O₅) was added to provide PPA with 83 percent P₂O₅ content and to ensure a final polymer concentration of 14 percent by weight in PPA. The composition was maintained and stirred at 100° C. to ensure good homogeneity and the temperature was slowly raised to 165° C. and the polymerization reaction was allowed to run for several hours. The polymerization reaction was continued at a final temperature of 180° C. for 24 hours, forming a “polymer dope.” The polymer dope was taken out of the flask for fiber spinning.

The polymer dope was transformed into PBO fibers using a system similar to that disclosed in FIG. 1 and the method described above. The polymer dope was filtered through a 74 μm stainless steel mesh and degassed at 100° C. The polymer dope was then extruded though a spinneret having a 20-mil diameter hole at 90° C. and under 1000-1100 psi pressure with high draw ratios in the 40-50 range. The extruded PBO fiber monofilament passed through an air gap, followed by sequential treatment in a series of three baths containing, in sequential order: distilled water, 5 percent aqueous ammonium hydroxide, and distilled water. The PBO fiber monofilament was then wound onto a spool. The spools of PBO fiber were further immersed in distilled water for a few days to remove any traces of ammonium hydroxide and then air-dried. Some of the PBO fibers were heat-treated in a stream of dry nitrogen at 300° C. for 30 seconds.

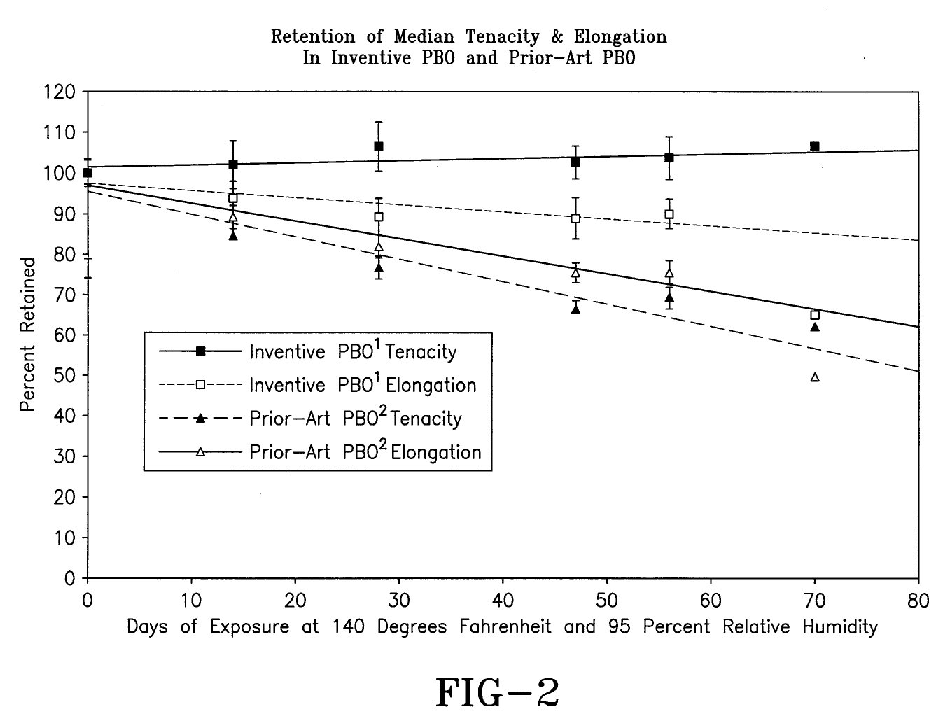

Various physical tests were performed on PBO fibers prepared according to the concepts of the present invention (which are referred to as “inventive PBO”). The same physical tests were performed on commercially available (prior-art) PBO fibers that had not undergone the three bath treatments (water, base, water) of the present invention. In particular, the tenacity (ultimate tensile strength per unit area) and elongation of the PBO samples were measured after periods of time in adverse environmental conditions (140° F. and 95 percent relative humidity). The median value results of these physical tests, which were normalized to account for initial differences in the number of filaments and heat treatment, are presented in Table I, and FIG. 2. The normalized values represent the ratio of each measured value to the initial, or, “as received” value. Thus, the normalized values provide an indication of the median percent tenacity and elongation retained over time.

TABLE I
PBO fibers prepared according to the concepts of the present invention retained
mechanical performance characteristics better than prior-art PBO fibers after exposure to
adverse temperature and humidity conditions.

| | Inventive PBO¹ | | | | Prior-Art PBO² | | | |
|---|---|---|---|---|---|---|---|---|
| | Tenacity | | Elongation | | Tenacity | | Elongation | |
| | (g/denier) | normalized | (%) | normalized | (g/denier) | normalized | (%) | normalized |
| As Received | 17.16 | 100 | 3.14 | 100 | 34.55 | 100.00 | 3.78 | 100.00 |
| 2 Weeks | 17.50 | 102 | 2.95 | 94 | 29.19 | 84.49 | 3.38 | 89.28 |
| 4 Weeks | 18.28 | 107 | 2.80 | 89 | 26.50 | 76.71 | 3.10 | 81.93 |
| 6.71 Weeks | 17.61 | 103 | 2.79 | 89 | 22.92 | 66.35 | 2.86 | 75.50 |
| 8 Weeks | 17.80 | 104 | 2.82 | 90 | 23.96 | 69.35 | 2.86 | 75.51 |
| 10 Weeks* | 18.30 | 107 | 2.04 | 65 | 21.47 | 62.14 | 1.88 | 49.64 |

¹Inventive PBO = 85 denier monofilament
²Prior Art PBO = Toyobo Zylon High Modulus 245 denier yarn, 5.25-5.5 TPI “Z”
*Tests at 10 weeks performed at 10 inches per minute.

The results disclosed in Table I are presented graphically in FIG. 2, which is a plot of the median percent tenacity and elongation retained over time by the inventive PBO and prior-art PBO samples. FIG. 2 shows that PBO fibers prepared according to the concepts of the present invention display a number of advantages over prior-art PBO fibers. PBO fibers treated with water, base, and then water display improved tenacity and elongation when exposed to adverse environmental conditions, as compared with prior-art PBO fibers. For example, the inventive PBO fibers do not exhibit a loss in tenacity even after 70 days of exposure to a temperature of 140° F. and 95 percent relative humidity. In contrast, prior-art PBO fibers exposed to the same conditions lost nearly 40 percent of their tenacity over the same time period. Also, the trends in the data indicate that the inventive PBO fibers retained much more of the original elongation than the prior-art PBO fibers, with the prior-art PBO fibers losing their elongation roughly 2.5 times as fast as the inventive PBO fibers.

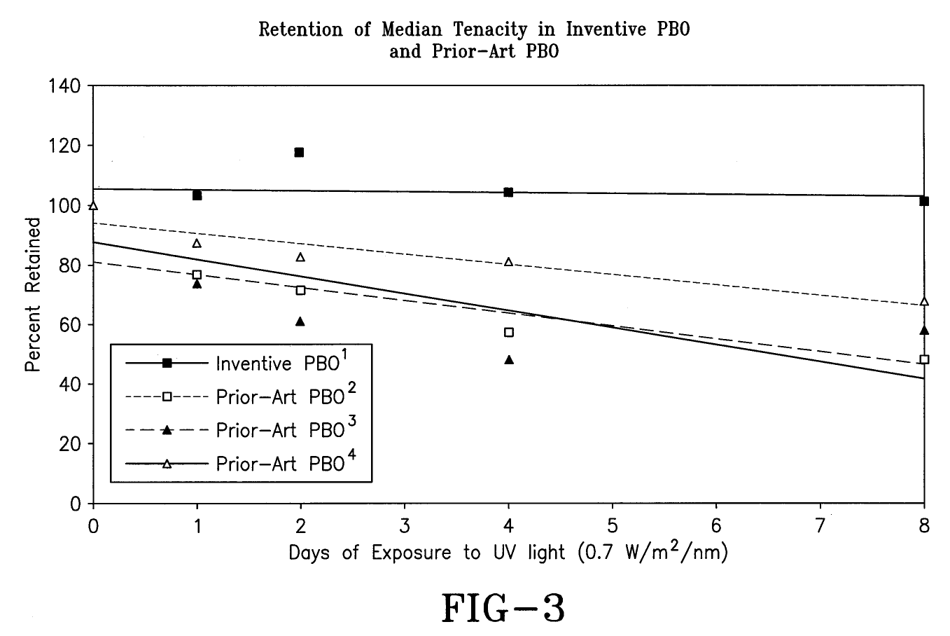

In addition, PBO fibers prepared according to the concepts of the present invention were compared to prior-art PBO fibers after periods of exposure to ultraviolet (UV) light. In particular, the PBO fibers were continually exposed to an amount of UV radiation equivalent to the amount of UV radiation in natural sunlight (created using a UVA-340 lamp at irradiance of 0.70 W/m²/nm), over a period of time, and the tenacity and elongation were measured. The median value results of these physical tests, which were normalized to account for initial differences in the number of filaments and heat treatment, are presented in Table II, and FIG. 3. The normalized values represent the ratio of each measured value to the initial, or, “as received” value. Thus, the normalized values provide an indication of the median percent tenacity and elongation retained over time.

TABLE II
PBO fibers prepared according to the concepts of the present invention retained
mechanical performance characteristics better than prior-art PBO fibers after exposure to
UV radiation.

| | Tenacity | | Elongation | | Tenacity | | Elongation | |
|---|---|---|---|---|---|---|---|---|
| | (g/denier) | normalized | (%) | normalized | (g/denier) | normalized | (%) | normalized |
| | Inventive PBO¹ | | | | Prior-Art PBO² | | | |
| As Received | 8.62 | 100 | 2.9 | 100 | 24.73 | 100 | 3.4 | 100 |
| 1 Day | 8.86 | 103 | 3.3 | 113 | 18.92 | 76 | 2.7 | 80 |
| 2 Days | 10.1 | 117 | 4.2 | 144 | 17.6 | 71 | 2.6 | 77 |
| 4 Days | 8.94 | 104 | 3.1 | 106 | 14.09 | 57 | 2.1 | 61 |
| 8 Days | 8.70 | 101 | 3.7 | 124 | 11.76 | 48 | 1.9 | 55 |
| | Prior-Art PBO³ | | | | Prior-Art PBO⁴ | | | |
| As Received | 32.73 | 100 | 5.6 | 100 | 33.13 | 100 | 4.1 | 100 |
| 1 Day | 24.01 | 73 | 4.5 | 80 | 28.91 | 87 | 3.8 | 94 |
| 2 Days | 20.0 | 61 | 3.5 | 63 | 27.3 | 82 | 3.6 | 89 |
| 4 Days | 15.67 | 48 | 3.2 | 58 | 26.91 | 81 | 3.6 | 88 |
| 8 Days | 18.83 | 58 | 3.6 | 64 | 22.35 | 67 | 3.2 | 78 |

¹Inventive PBO = 85 denier monofilament
²Prior Art PBO = Toyobo Zylon High Modulus 245 denier yarn, 5.25-5.5 TPI “Z”
³Prior Art PBO = Toyobo Zylon As Spun 278 denier yarn, no twist
⁴Prior Art PBO = Toyobo Zylon High Modulus 545 denier yarn, no twist

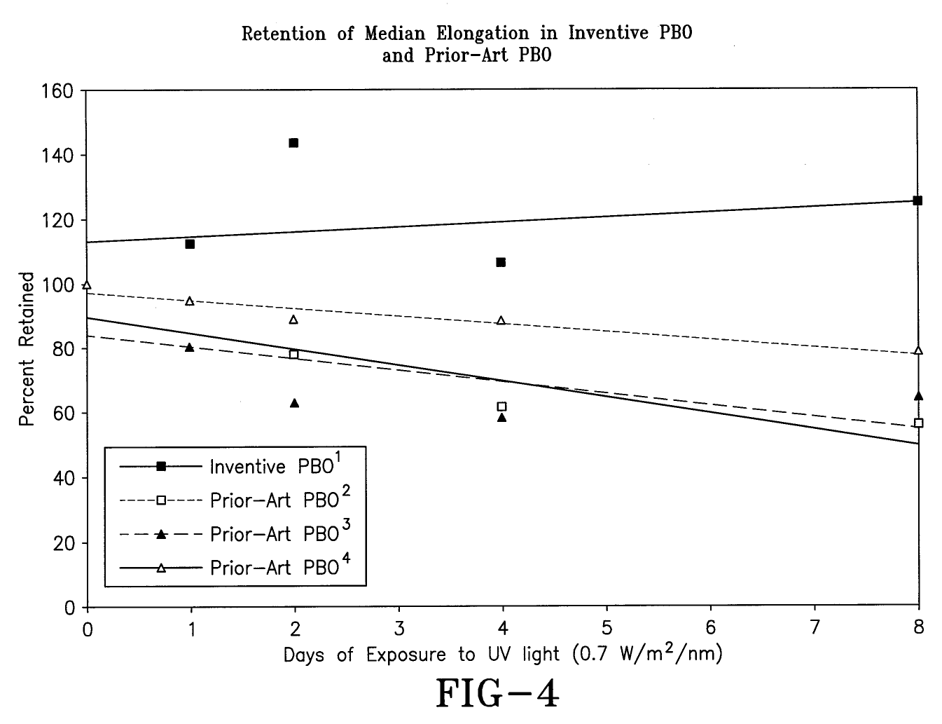

The results disclosed in Table II are presented graphically in FIGS. 3 and 4, which are plots of the median percent tenacity and elongation retained over time by the inventive PBO and prior-art PBO samples. Those figures show that PBO fibers prepared according to the concepts of the present invention display a number of advantages over prior-art PBO fibers. PBO fibers treated with water, base, and then water display improved tenacity and elongation when exposed to UV radiation equivalent to the UV of natural sunlight, as compared with prior-art PBO fibers. For example, FIG. 3 shows that the inventive PBO fibers do not exhibit a loss in tenacity after eight days of continuous exposure to UV radiation. In contrast, prior-art PBO fibers exposed to the same conditions lost approximately 30 to 40 percent of their tenacity over the same time period. FIG. 4 shows that the PBO fibers prepared according to the concepts of the present invention did not exhibit decreased elongation after eight days of continuous UV exposure. Prior-art PBO fibers, however, lost between 20 and 45 percent of their elongation over the same period.

PBO fibers prepared according to the concepts of the present invention have a residual phosphorus content of 0.090 percent as measured by elemental analysis, representing a corresponding phosphoric acid content of 0.28 percent by weight. Prior-art PBO fibers have an average residual phosphorus content of 0.38 percent as measured by elemental analysis, representing a corresponding phosphoric acid content of 1.2 percent by weight. In particular, Toyobo Zylon as-spun 278 denier yarn (Prior-Art PBO³) was found to have a residual phosphorous content of 0.39 percent, representing a corresponding phosphoric acid content of 1.2 percent by weight. Toyobo Zylon high modulus 545 denier yarn (Prior-Art PBO⁴) had residual phosphorous content values as high as 0.60 percent, representing a corresponding phosphoric acid content of 1.9 percent by weight. Chlorine content was below the measurable limits (0.13 percent Cl) for duplicate tests of both the inventive and prior-art samples. Thus, PBO fibers prepared according to the concepts of the present invention have less residual phosphoric acid content than prior-art PBO fibers. In other words, removing residual acid in situ during fiber processing while the fibers are still wet and permeable to the neutralizing reagent has been found to lead to a significant improvement in the final properties of the fiber.

Furthermore, treating the prior-art PBO fibers in the base, water, and base baths as disclosed above (for hours or even days) did not reduce the residual phosphorous content as measured by elemental analysis. This confirms the conclusion that removing residual acid in situ during fiber processing while the fibers are still wet and permeable to the neutralizing agent is preferable to post-fabrication treatment. Indeed, inasmuch as post-fabrication treatments using base compounds have proven to be ineffective, the improved results realized by the present invention are unexpected.

A further advantage of PBO fibers prepared according to the concepts of the present invention is that treating PBO fibers with water, base, and then water is less costly and more effective than previous methods of treating PBO fibers for prevention of hydrolysis.

Thus, it can be seen that the objects of the invention have been satisfied by the structure and its method for use presented above. While in accordance with the Patent Statutes, only the best mode and preferred embodiment have been presented and described in detail, it is to be understood that the invention is not limited thereto or thereby. Accordingly, for an appreciation of the true scope and breadth of the invention, reference should be made to the following claims.

What is claimed is:

1. A method of preparing a rigid-rod polymer fiber comprising:
preparing a polymer solution;
extruding the polymer solution to form a filament;
exposing said filament to an aqueous base solution.

2. The method of claim 1, further comprising the step of:
exposing said filament to water.

3. The method of claim 2, wherein exposing said filament to water is performed before and after said step of exposing said filament to said aqueous base solution.

4. The method of claim 3, further comprising:
completely submerging said filament in a water bath during said steps of exposing said filament to water; and
completely submerging said filament in a base bath during said step of exposing said filament to an aqueous base solution.

5. The method of claim 4, further comprising:
providing said water bath with distilled water; and
providing said base bath with 5 percent aqueous ammonium hydroxide.

6. The method of claim 2, further comprising:
heat-treating said filament.

7. The method of claim 2, further comprising:
winding said filament onto a spool, and
submerging said spool into a bath containing distilled water.

8. The method according to claim 1, further comprising:
preparing said polymer solution to form poly (p-phenylene-benzobisoxazole).

9. A rigid-rod polymer fiber having a residual acid content of less than about 1.00 percent phosphoric acid content by weight.

10. The rigid-rod polymer fiber of claim 9, wherein said residual acid content is less than about 0.80 percent phosphoric acid content by weight.

11. The rigid-rod polymer fiber of claim 9, wherein said residual acid content is less than about 0.60 percent phosphoric acid content by weight.

12. The rigid-rod polymer fiber of claim 9, wherein said residual acid content is less than about 0.40 percent phosphoric acid content by weight.

13. The rigid-rod polymer fiber of claim 9, wherein said residual acid content is less than about 0.30 percent phosphoric acid content by weight.

14. The fiber of claim 9, wherein said polymer comprises poly (p-phenylene-benzobisoxazole).
